(19) United States
(12) Patent Application Publication
(10) Pub. No.: US 2004/0154851 A1
(43) Pub. Date: Aug. 12, 2004

(54) Engine mount

(76) Inventors: Alain Massicotte, Orford (CA); Yves Berthiaume, Mont-St-Hilaire (CA)

Correspondence Address: BOMBARDIER RECREATIONAL PRODUCTS, LEGAL SERVICES - ST-BRUNO, PO BOX 230, NORTON, VT, 05907-0230, US

(21) Appl. No.: 10/771,387

(22) Filed: Feb. 5, 2004

Related U.S. Application Data
(60) Provisional application No. 60/444,949, filed on Feb. 5, 2003.

(51) Int. Cl. B62M 27/02

(52) U.S. Cl. 180/190

(57) ABSTRACT

A wheeled vehicle is described that includes a frame with at least a front wheel and a rear wheel. A seat is disposed on the frame as well. An engine, having an output shaft, is connected to the frame via an engine mount. A second shaft, operatively connected to the engine's output shaft, is supported by the engine mount. So constructed, the output shaft of the engine and the second shaft supported by the engine mount are maintained in a relatively fixed positional relationship with respect to one another.

### CROSS-REFERENCE TO RELATED APPLICATION(S)

This application relies for priority on U.S. Provisional Patent Application Serial No. 60/444,949, entitled “CONTINUOUSLY VARIABLE TRANSMISSION AND REAR ENGINE MOUNT,” which was filed on Feb. 5, 2003, the contents of which are incorporated herein by reference.

### FIELD OF THE INVENTION

The present invention relates to an engine mount for a vehicle. More precisely, the invention concerns an engine mount for supporting and positioning an engine and its associated transmission.

### BACKGROUND OF THE INVENTION

During operation, a continuously variable transmission (“CVT”) is sensitive to variation in the distance between the drive and driven pulleys, which comprise the CVT.

On a vehicle such as a snowmobile, for example, the drive pulley is located on the engine and the driven pulley is located elsewhere on the vehicle, typically positioned on the frame of the vehicle. As a result, the drive pulley and the driven pulley are not located on the same structure (or casing) such that the distance between them remains constant. Accordingly, during operation, the drive and the driven pulleys can and do experience distance variations between them.

It is well known in the art that an engine lacking a transmission usually requires some sort of speed reducing device before the engine rotation is transmitted to the propulsion device, such as a tire. This is also true where the engine includes a transmission that fails to provide the correct power ratio for the propulsion device in which the power unit is installed. In either case, it is necessary to provide an external speed reduction or speed augmentation device between the power unit and the propulsion device.

As would be appreciated by those skilled in the art, where an engine speed reduction device is incorporated into the vehicle design, the reduction device must be incorporated into the mechanical layout for the vehicle. Usually, this means that a gearbox (an engine speed reduction device) is connected to the frame of the vehicle. As a general rule of thumb, those skilled in the art would understand that the engine's output speed (RPM) is usually higher than the speed of the final output shaft operatively connected to the propulsion device, such as a rear wheel. Moreover, the final ratio at Wide Open Throttle (“WOT”) typically varies between 0.9:1 to 1.1:1, which means that the speed reduction device sometimes operates as a reducer and sometimes operates as an augmenter.

A problem arises when the vehicle layout must accommodate a CVT, because the drive and the driven pulleys must be maintained in the correct positional relationship with respect to one another to avoid mechanical wear and failure. During operation, the drive pulley, which is usually connected to the engine, has a tendency to move with respect to the driven pulley mounted on the frame of the vehicle. This effect is particularly pronounced where the engine is mounted to the frame via rubber mounts.

With vehicles that incorporate a CVT, it is possible to construct the vehicle so that the drive and driven pulleys are properly aligned, at least at the manufacturing stage. However, a difficulty may arise when maintenance is performed on the vehicle and one of either the drive or driven pulleys are removed and reinstalled. Once reinstalled, it is possible that the two pulleys may no longer be aligned optimally, which may result in subsequent operational difficulties and/or degradation of one or both of the pulleys or the belt that connects them operatively.

Separate from reliance on a CVT, an external secondary transmission may represents a good design choice for vehicles because the same engine can be used in different applications (i.e., in different vehicle types). However, the secondary transmission must be fastened somewhere on the vehicle. If the engine is rubber mounted on the vehicle, everything that is not fixed to the engine will experience distance variations with respect to the engine when the engine vibrates, potentially resulting in operational misalignment.

Connection points between the frame and the engine may be spaced distantly from one another. Long engine mounts may be needed to link the engine to the frame. The engine mounts may have sufficient length to serve other purposes. Each of these factors present other variables that may have an impact on the variable distances between the engine, frame and associated components that may further complicate the design of the vehicle.

As a result, a need has arisen for a simplified construction that compensates for positional variability between vehicle components during operation.

Among others, a need has arisen for an engine mount that minimizes the impact on transmission components resulting from distance variations between the engine and transmission during operation.

In addition, a need has developed for an engine mount that permits the engine to be rubber-mounted to a vehicle's frame while maintaining the engine and separate transmission component(s) in a fixed positional relationship.

### SUMMARY OF THE INVENTION

One aspect of an embodiment of the present invention provides an engine mount connecting an engine to a frame and supporting a shaft connected to a speed reduction mechanism.

Another aspect of an embodiment of the invention presents an input shaft entering the speed reduction mechanism and an output shaft exiting the speed reduction mechanism, where the two shafts are disposed on the same axis.

Another aspect of an embodiment of the invention presents an input shaft entering the speed reduction mechanism and an output shaft exiting the speed reduction mechanism that are disposed on different axes.

It is one other aspect of an embodiment of the invention to provide a rigid connection between the CVT drive pulley and the CVT driven pulley when the engine is rubber mounted.

It is another aspect of the invention to provide a CVT driven pulley support that includes a gearbox.

It is an aspect of this invention to allow the engine and the CVT driven pulley to be held by the same engine mount.

One aspect of the invention provides a engine support that incorporates a gearbox.

Another aspect of this invention is to include a bearing or a bushing in the engine mount.

An aspect of the invention include a gear or a bearing in the engine support for supporting a shaft transferring power form the engine to the driven wheel.

Accordingly, one aspect of the invention provides a wheeled vehicle with a frame and at least one front wheel, one rear wheel, and a seat mounted on the frame. An engine, with an output shaft, is connected to the frame via an engine mount, the engine having an output shaft. A second shaft, which is operatively connected to the engine's output shaft, is supported by the engine mount.

In addition, another aspect of the invention provides a wheeled vehicle a frame and at least one front wheel, one rear wheel, and a seat mounted on the frame. An engine, with an output shaft, is connected to the frame via an engine mount, the engine having an output shaft. A second shaft, which is operatively connected to the engine's output shaft, is supported by the engine mount. A speed reduction mechanism is connected to the engine mount.

Other advantages and salient features of the invention will become apparent from the following detailed description, which, taken in conjunction with the annexed drawings, disclose preferred embodiments of the invention.

### BRIEF DESCRIPTION OF THE DRAWINGS

The present invention will now be described in connection with the appended figures. Where appropriate, like reference numerals will be used to denote like parts, wherein:

FIG. 1 is a top view of the engine, frame and CVT layout of one embodiment of the invention as applied to a wheeled vehicle, such as a two-wheeled vehicle;

FIG. 2 is a rear view of the engine, frame and CVT layout depicted in FIG. 1;

FIG. 3 is a perspective view of the motor mount depicted in FIGS. 1 and 2;

FIG. 4 is an enlarged, perspective view of the driven CVT pulley and the motor mount shown in FIG. 3;

FIG. 5 is a side view of the motor mount illustrated in FIG. 4;

FIG. 6 is a perspective view of the motor mount connected to the frame and the engine that is shown in FIG. 5;

FIG. 7 is a schematic illustration of an additional embodiment of the invention;

FIG. 8 is a schematic illustration of yet another embodiment of the invention; and

FIG. 9 is a schematic illustration of one possible planetary gear arrangement that may be utilized in the embodiment of the invention illustrated in FIG. 8.

### DESCRIPTION OF THE PREFERRED EMBODIMENT(S)

As described herein, the invention is intended for use on a two-wheeled vehicle such as a motorcycle or moped, for example. However, the invention is not intended to be limited solely to applicability to two wheeled vehicles. To the contrary, the invention is intended to have wide applicability to any vehicle in which an engine is mounted. For example, the invention may be employed in all terrain vehicles (“ATVs”), other types of four-wheeled vehicles, three-wheeled vehicles, snowmobiles, personal watercraft, or any other suitable vehicles propelled by a propeller, jet drive, wheels, or an endless drive track (as in the case of a snowmobile) where a reduction device is disposed between the engine and the propulsion device. Herein, the term “propulsion device” is intended to encompass any type of propulsion device including, but not limited to, a propeller, one or more tires, and one or more endless drive tracks.

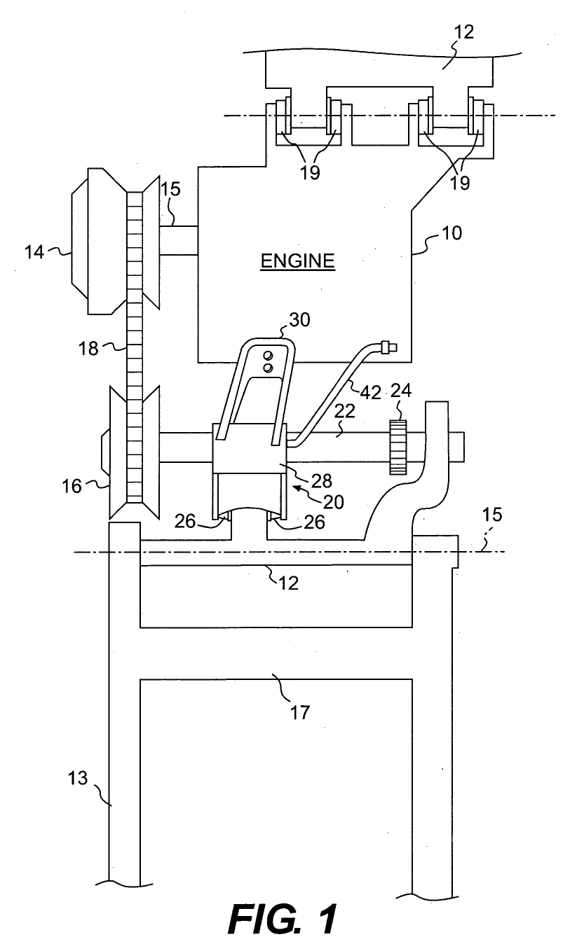

FIG. 1 illustrates a top view of one embodiment of the invention. As shown, an engine 10 is connected to a frame 12. A CVT drive pulley 14 is operatively connected to the engine 10. In the preferred orientation, the CVT drive pulley 14 is connected to the output shaft 15 of the engine 10 and is driven thereby. The CVT drive pulley 14 is operatively linked to a CVT driven pulley 16 using a belt 18. An engine mount 20 connects the engine 10 to the frame 12.

In the illustrated embodiment, the engine 10 connects to the frame 12 at three locations. The engine mount 20 secures the engine 10 to the frame toward a rear end thereof. In particular, the engine 10 is connected to a portion of the frame 12 proximal to a rear swing arm 13 of the vehicle in which the invention is mounted. The rear swing arm 13 is disposed on the frame 12 such that it pivots about a swing arm pivot axis 15. Lateral sides of the swing arm 13 connect to one another via a cross-brace 17.

As FIG. 1 shows, a CVT driven pulley shaft 22 passes through the center of the driven CVT pulley 16 and extends from one side of the frame 12 to the other. The CVT driven pulley shaft 22 may connect to a driver sprocket 24. The driver sprocket 24 may, in turn, operatively connect to a rear wheel of a two-wheeled vehicle via a chain, belt, drive shaft, or other operative connection known to those skilled in the art. Alternatively, the driver sprocket may connect to any suitable propulsion device.

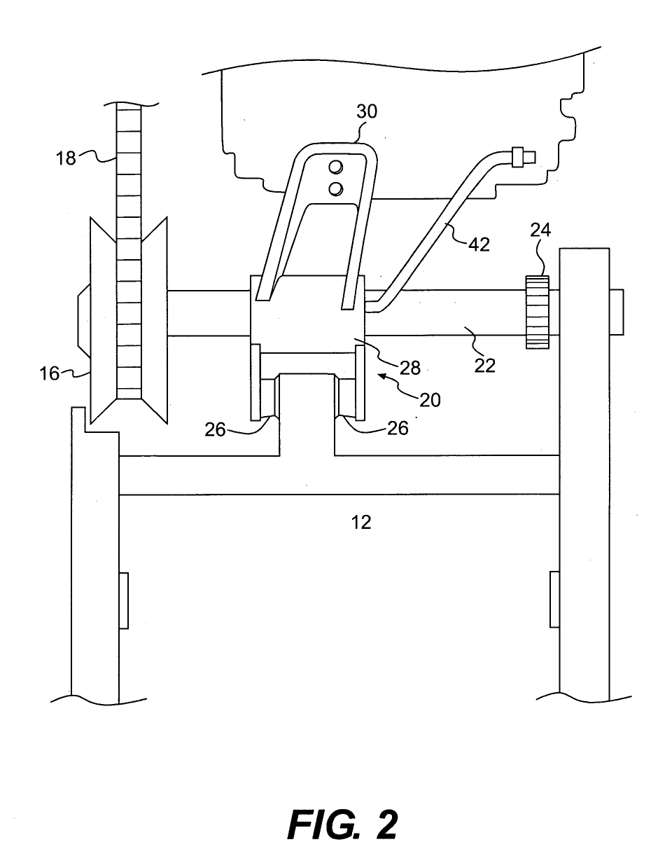

As illustrated in FIG. 2, the motor mount 20 preferably connects to the frame 12 via two rubber mounts 26 at the rear and four rubber mounts 19 at the front. The rubber mounts 19, 26 reduce the transmission of vibrations generated by the engine 10 to the frame 12. In other words, the rubber mounts 19, 26 isolate the engine 10 from the frame 12, thereby enhancing operational characteristics of the vehicle.

A middle part 28 of the engine mount 20 may include a gearbox or a reduction system to change the drive (or rotation) ratio between the CVT driven pulley 16 and the driver sprocket 24. Alternatively, the middle part 28 may not include a gearbox or a reduction (or augmentation system) but, instead, may include a bearing or bushing. As illustrated in FIG. 1, the CVT driven pulley shaft passes through the middle part 28 of the engine mount 20. The rigid connection 30 between the engine 10 and the motor mount 20 maintains a constant distance between the CVT drive pulley 14 and the CVT driven pulley 16.

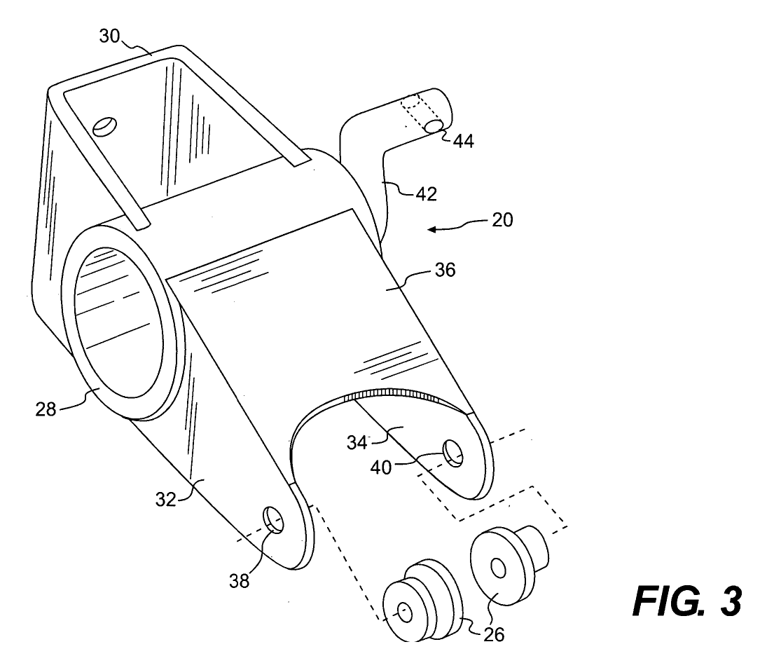

FIG. 3 provides a perspective view of the engine mount 20 of the invention. The engine mount 20 includes two side portions 32, 34 that extend rearwardly from the middle portion 28. The rigid connection 30, which is generally a U-shaped member, extends forwardly from the middle portion 28. The side portions 32, 34, the middle portion 28, and the rigid connector 30 preferably are manufactured from aluminum, steel, or any other suitable metal or alloy. Alternatively, the components of the engine mount 20 may be manufactured from a non-metallic material, if desired.

The side portions 32, 34 of the engine mount 20 are connected to one another via a plate 36 that extends therebetween. The plate preferably is made of the same material as the side portions 32, 34 and the remaining components of the engine mount 20. The side portions 32, 34, the plate 36, and the rigid connector 30 are all preferably fastened to the middle portion 28 via welds. Of course, as would be appreciated by those skilled in the art, the connection of the various components to form the engine mount 20 may be via any other suitable fastener such as adhesive, nuts and bolts, etc.

As illustrated in FIG. 3, the side portions 32, 34 include holes 38, 40 so that the engine mount 20 may be fastened to the frame 20, as illustrated in FIGS. 1 and 2. For convenience of understanding, the rubber mounts 26 are shown in FIG. 3 as well. The rubber mounts 26 are disposed between the engine mount 20 and the frame 12 as previously discussed.

The engine mount 20 also may include a stabilizing bar 42 connected thereto. If included, the stabilizing bar 42 connects to the engine 10 via a bolt passing through the hole 44 at the distal end thereof. If included, the stabilizing bar 42 supplies additional rigidity to the connection between the frame 12 and the engine 10. As would be appreciated by those skilled in the art, additional stabilizing bars also could be connected to the engine mount 20, if needed.

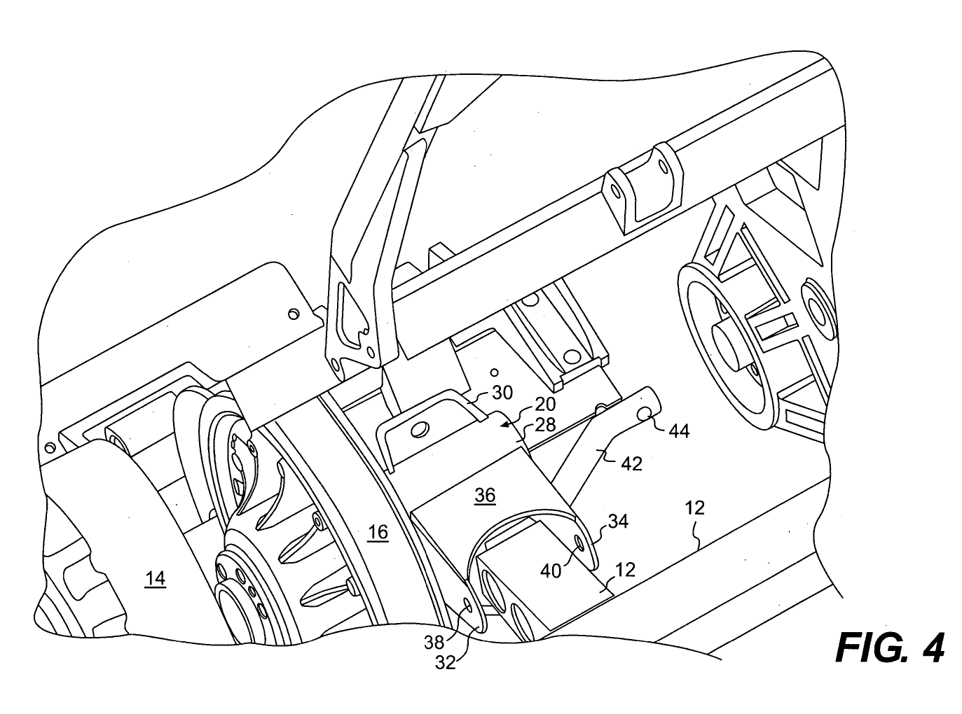

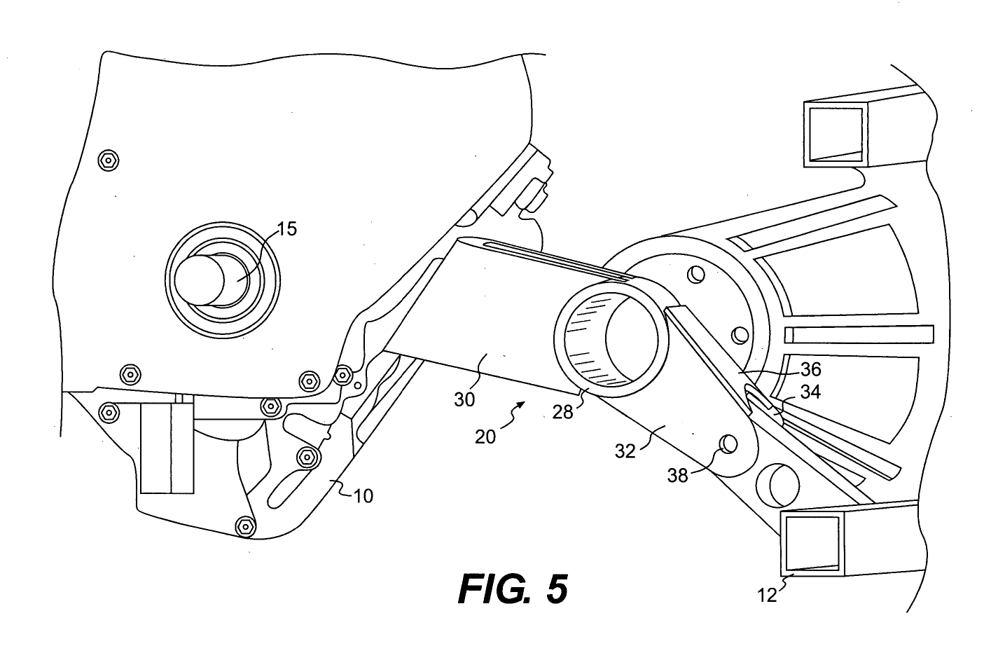

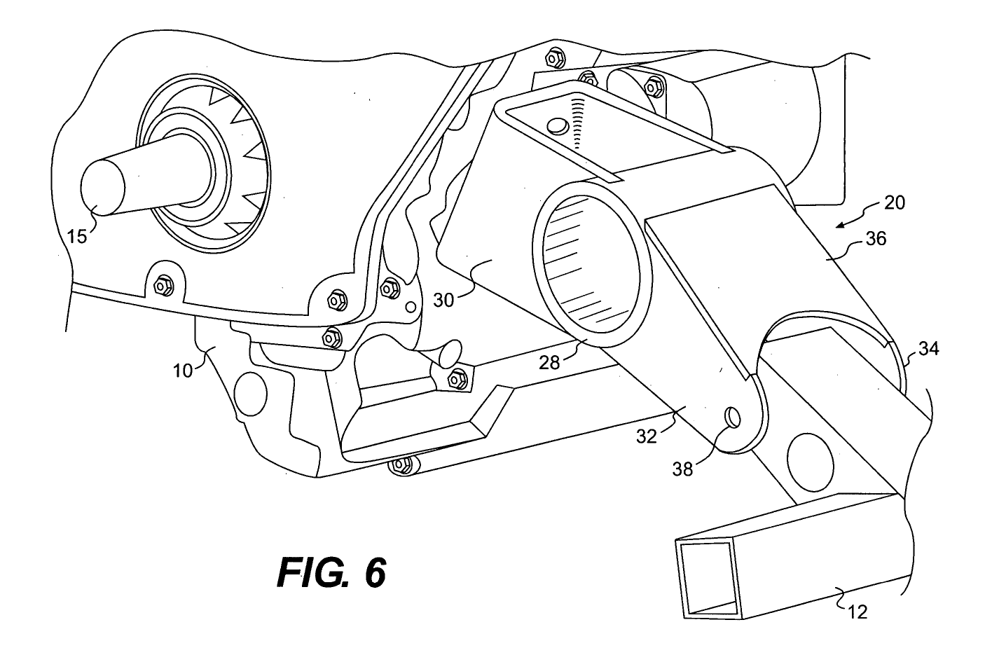

FIG. 4 provides an enlarged perspective illustration of the position of the engine mount 20 on the frame 12 of the vehicle. The illustration omits the rubber mounts 26 to facilitate an understanding of the positional relationship between the engine mount 20 and the frame 12. For clarity, FIGS. 5 and 6 provide two additional, perspective illustrations of the engine mount 20, shown disposed between the engine 10 and the frame 12.

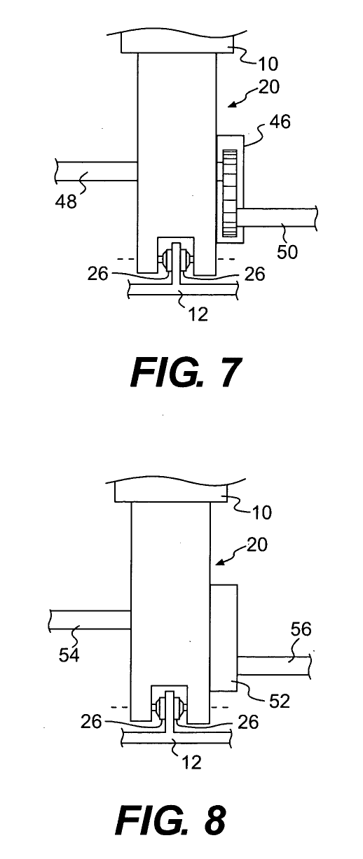

FIG. 7 is a schematic illustration of another embodiment of the invention. Here, the engine mount 20 is intended to be the same as the engine mount 20 discussed in connection with FIGS. 1-5. In FIG. 7, however, a gear box 46 is attached to the engine mount 20. The gear box 46, which provides geared speed reduction (or augmentation), is connected to an input shaft 48 that passes through the middle portion 28 of the engine mount 20, as in the previous embodiment. The input shaft 48 may be the CVT driven pulley shaft 22 or it may not. Regardless of whether or not the engine 10 includes a traditional transmission or a CVT, the gear box 46 may be provided to further reduce or augment shaft speed before power is transmitted to the propulsion device. An output shaft 50 extends from the gear box 46 and may connect to a sprocket 24 as illustrated in FIG. 1.

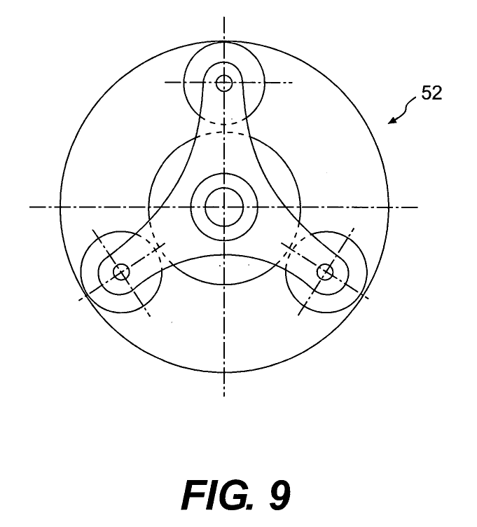

FIG. 8 illustrates yet another embodiment of the invention. In this figure, the gear box 52 includes a planetary gearing. The embodiment includes an input shaft 54 and an output shaft 56, as in the previous embodiment. FIG. 9 provides a schematic of one type of planetary gearing arrangement, which may be used for the gear box 52.

Regardless of the embodiment employed, one aspect of the invention is the disposition of the CVT driven shaft 22 or the input shaft 48, 54 through the middle portion 28 of the engine mount 20. As would be appreciated by those skilled in the art, preferably a bearing or bushing (not shown) is disposed within the middle portion 28 of the engine mount 20 to hold the shaft 22, 48, 54 rotationally therein. So positioned, the shaft 22, 48, 54 is held in a fixed positional relationship with respect to the engine 10. In other words, the engine mount 20, which is connected to both the engine 10 and the shaft 22, 48, 54, maintains the engine 10 and the shaft 22, 48, 54 in a fixed positional relationship to minimize (or substantially eliminate) any distance variation therebetween during operation. Moreover, even if components associated with the shaft 22, 48, 54, such as the CVT driven pulley 16, are removed from the shaft 22, 48, 54 for maintenance and subsequently reinstalled, the engine mount 20 maintains the positional relationship between the engine 10 and the shaft 22, 48, 54. As such, when the engine 10 is operatively connected to a CVT, which is the preferred embodiment, the CVT drive pulley 14 and the CVT driven pulley 16 are maintained in the same (or substantially the same) fixed positional relationship during their operational lifetime. This greatly enhances the operational lifetime of the vehicle by minimizing (or eliminating) wear on the drive components due to distance variation between the CVT drive pulley 14 and the CVT driven pulley 16, for example. This advantage is provided in an arrangement where the engine 10 is rubber-mounted to the frame 12 so that engine vibrations may be isolated from the frame 12.

It is noted that, while the engine mount 20 of the invention provides a fixed positional relationship between the engine 10 and the CVT driven shaft 22 or the input shafts 48, 54, in the embodiments described, it is contemplated that the engine mount could be employed in any environment where a fixed positional relationship is needed between an engine and a rotating shaft. Alternatively still, other environments into which the invention may be incorporated will be appreciated by those skilled in the art.

The preferred orientation of the invention is such that the engine mount 20 is disposed between the engine 10 and a rear tire of the vehicle where the invention is employed. In particular, the engine mount 20 preferably attaches to a portion of the frame 12 at the rear of the vehicle. Specifically, it is contemplated that the engine mount 20 will be disposed between the engine 10 and a rear swing arm 13 for the vehicle. So configured, it is preferred that the CVT driven shaft or the output shaft 50, 56 be aligned (or at least substantially aligned) with the pivot axis 15 of the rear swing arm 13. This is preferred primarily because it is contemplated that the sprocket 24 will be disposed on the shaft 22, 50, 56. This position is preferred to maintain a fixed distance between the sprocket 24 and the rear tire, regardless of the angular orientation of the rear swing arm in relation to the frame 12 of the vehicle. It is contemplated that the drive sprocket will transfer power to the rear tire via a chain, belt, or drive shaft.

The foregoing description is included to illustrate the operation of one preferred embodiment of the invention and is not meant to limit the scope of the invention in any way. Variations on the described embodiment will be apparent to those skilled in the art and such variations are intended to fall within the scope of the invention, as evidenced by the claims appended hereto.

What is claimed is:

1) a wheeled vehicle comprising:
a) a frame;
b) at least one front wheel disposed on the frame;
c) at least one rear wheel disposed on the frame;
d) a seat disposed on the frame;
e) an engine connected to the frame via an engine mount, the engine having an output shaft; and
f) a second shaft supported by the engine mount, the second shaft being operatively connected to the output shaft.

2) A wheeled vehicle as claimed in claim 1, wherein the engine mount further comprises a bearing supporting the second shaft.

3) A wheeled vehicle as claimed in claim 1, further comprising a continuously variable transmission driven pulley disposed on the second shaft.

4) A wheeled vehicle as claimed in claim 1, further comprising a sprocket disposed on the second shaft.

5) A wheeled vehicle as claimed in claim 1, wherein the engine mount isolates the frame from vibration generated by the engine.

6) A wheeled vehicle as claimed in claim 1, further comprising a speed reduction mechanism connected to the engine mount.

7) A wheeled vehicle as claimed in claim 6, wherein the speed reduction mechanism comprises at least one gear.

8) A wheeled vehicle as claimed in claim 3, wherein the engine mount is located between the continuously variable transmission driven pulley and a sprocket disposed on the second shaft.

9) A wheeled vehicle as claimed in claim 1, wherein the vehicle has less than four wheels.

10) A wheeled vehicle as claimed in claim 1, wherein the engine mount is disposed between the engine and the rear wheel.

11) A wheeled vehicle comprising:
a) a frame;
b) at least one front wheel disposed on the frame;
c) at least one rear wheel disposed on the frame;
d) a seat disposed on the frame;
e) an engine mount connected to the frame;
f) an engine connected to the engine mount, the engine having an output shaft; and
g) a speed reduction mechanism connected to the engine mount, the speed reduction mechanism having an input shaft and an output shaft.

12) A wheeled vehicle as claimed in claim 11, wherein the wheeled vehicle comprises less than four wheels.

13) A wheeled vehicle as claimed in claim 12, further including a continuously variable transmission having a drive pulley operatively connected to the engine output shaft and a driven pulley connected to the speed reduction mechanism input shaft.

14) A wheeled vehicle as claimed in claim 13, further including a rear suspension pivotally connected to the frame, the connection defining an axis, the speed reduction mechanism output shaft being substantially aligned with the axis.

15) A wheeled vehicle as claimed in claim 11, wherein the engine mount isolates the frame from vibration generated by the engine.

16) A wheeled vehicle comprising:
a) a frame;
b) one front wheel disposed on the frame;
c) one rear wheel disposed on the frame;
d) a straddle-type seat disposed on the frame;
e) a handlebar disposed on the frame, the handlebar being operatively connected to the front wheel to steer the wheeled vehicle;
f) an engine mount connected to the frame;
g) an engine connected to the engine mount, the engine having an output shaft; and
h) a speed reduction mechanism connected to the engine mount, the speed reduction mechanism having an input shaft and an output shaft.

17) A wheeled vehicle as claimed in claim 16, further including a continuously variable transmission having a drive pulley operatively connected to the engine output shaft and a driven pulley connected to the speed reduction mechanism input shaft.

18) A wheeled vehicle as claimed in claim 16, further including a rear suspension pivotally connected to the frame, the connection defining an axis, the speed reduction mechanism output shaft being substantially aligned with the axis.

19) A wheeled vehicle as claimed in claim 16, wherein the engine mount isolates the frame from vibration generated by the engine.
